(19) United States
(12) Patent Application Publication
(10) Pub. No.: US 2005/0257846 A1
(43) Pub. Date: Nov. 24, 2005

(54) Method and apparatus for abandoning a sewer pipe using a cured in place sewer plug

(76) Inventor: Marvin Nordling JR., New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/134,970

(22) Filed: May 23, 2005

Related U.S. Application Data
(60) Provisional application No. 60/573,568, filed on May 21, 2004.

(51) Int. Cl. F16L 55/12

(52) U.S. Cl. 138/93; 138/98

(57) ABSTRACT

The present invention provide a method for abandoning a sewer pipe, such as an abandoned lateral line that employs an inflatable sewer plug impregnated with resin which is either pushed into place or pulled into place, frequently in a lateral sewer line, inflated and allowed to cure thus blocking the flow of liquid into a main sewer line.

### PRIORITY

This application claims the priority of U.S. Provisional Application Ser. No. 60/573,568, filed May 21, 2004.

### FIELD OF THE INVENTION

The present invention relates to sewer pipes and systems. More specifically, the present invention provides a method and apparatus for permanently abandoning a sewer line.

### BACKGROUND OF THE INVENTION

Sewer systems are normally constructed such that a main line runs underneath a street, frequently in front of a row of buildings, e.g. houses. A perpendicularly disposed lateral line is then used to connect each of the buildings to the main line. Generally, the design of the sewer system coincides with the intended use of the system. Accordingly, in a residential area, a plurality of laterals are connected at regular intervals to the main line. Such would not be the case in a system used, for example, in a more commercial real estate application.

Unfortunately for the sewer system, land use often changes substantially over time. For example, as above, the formerly residential area may be converted for use as a commercial parking lot. In that event, several of the laterals that formerly served each home would need to be blocked while still allowing for utilization of the main sewer line.

Frequently, main sewer lines run underneath streets such that buildings on either side of the street can be equally served. Obviously, it is a substantial inconvenience and expense to tear up a road to remove a lateral sewer line and plug the main sewer line. Therefore, what is needed is a method for plugging a lateral sewer line permanently without resorting to excavating the lateral sewer line and plugging the main sewer line.

The laterals need to be permanently blocked so as to prevent water and other waste infiltration into the sewer system. In the experience of this inventor, and while water infiltration from abandoned laterals is difficult to measure, it can be a major cause of backups and overflows within the system. Stopping these backups and overflows will be especially important in the future as the Environmental Protection Agency, as well as local regulatory authorities promulgate new rules regarding the capacity, management, operations and maintenance of sewers designed to reduce the risk of sewer overflows.

Current methods involve the use of grout to seal an abandoned sewer lines. In general, grout is pumped into the sewer lateral to be abandoned and allowed to cure. After it is allowed to cure, it is pressure tested to determine the integrity of the seal. Unfortunately, grout often shrinks and/or deteriorates with age, so concerns frequently arise as to whether the use of grout is really an acceptable permanent solution to abandon sewer laterals. Other methods also exist, such as the use of inflatable plugs. Similar durability concerns exist with these types of plugs.

### SUMMARY OF THE INVENTION

The present invention provides a method and apparatus for abandoning a sewer pipe, particularly a lateral sewer pipe. More specifically, the present invention provides for a method and apparatus for curing a plug for an abandoned sewer line, such as a lateral, in place. The present invention also provides for a method of locating the plug within the sewer line. Further, the present invention provides for the use of electronic sensor technology to locate the plug. Additionally, the present invention may provide for the use of a minicamera or fiberoptic device to locate the plug within the sewer line.

In more detail, the method of the present begins with the laying out of a longitudinally extending bladder. In the experience of this inventor, the optimum bladder length is about six feet. The bladder is lined with a flexible, impermeable layer that is airtight. The bladder is covered by a white fibrous material, or felt. The felt is generally covered in a plastic material.

Next, the bladder is completely coated on the outside and on the inside with a material that will cure at an ambient temperature, such as an epoxy resin. The bladder is first partially filled with the resin and becomes porous within it. At this point, the material within the bladder can be rolled to more evenly distribute the epoxy equally within the bladder. The present invention also provides for the use of a dye with the epoxy so that epoxy dispersion is easily observable throughout the felt sleeve.

The outside of the bladder is coated with the epoxy as well. The bladder is then folded in half along its length lengthwise and taped. An air hose is connected to the opposite end of the bladder and the bladder is pushed into the sewer line using a push pole. The first end of the bladder includes a cavity which receives the end of the push pole so that it can be pushed into the line. A second line is included so as to allow for retrieval of the bladder if such is desired or required. The air hose line goes in as well with the end result that the bladder is pushed to a certain point within the lateral which is predetermined by the installers. Once the bladder is in place, the push pole line is withdrawn and the air line is activated so as to inflate the bladder thereby pushing the walls of the bladder up against the outer surfaces of the sewer line. The air pressure is maintained until the epoxy “sets.” At that point the air line can be withdrawn from the bladder and the bladder is in place. The “setup” time for the epoxy used by this inventor is approximately four hours.

### BRIEF DESCRIPTION OF THE DRAWINGS

FIG. 1 shows a schematic view of an exemplary main sewer line having a lateral connected to a building, showing one method of installing the present invention.

FIG. 2 shows a schematic view of an exemplary main sewer having a lateral connected to a building, showing yet another method for installing the cured in place sewer plug.

FIG. 3A shows a top elevational view of the cured in place sewer plug.

FIG. 3B shows a top elevationa view of the cured in place sewer plug immediately before installation.

### DETAILED DESCRIPTION OF THE INVENTION

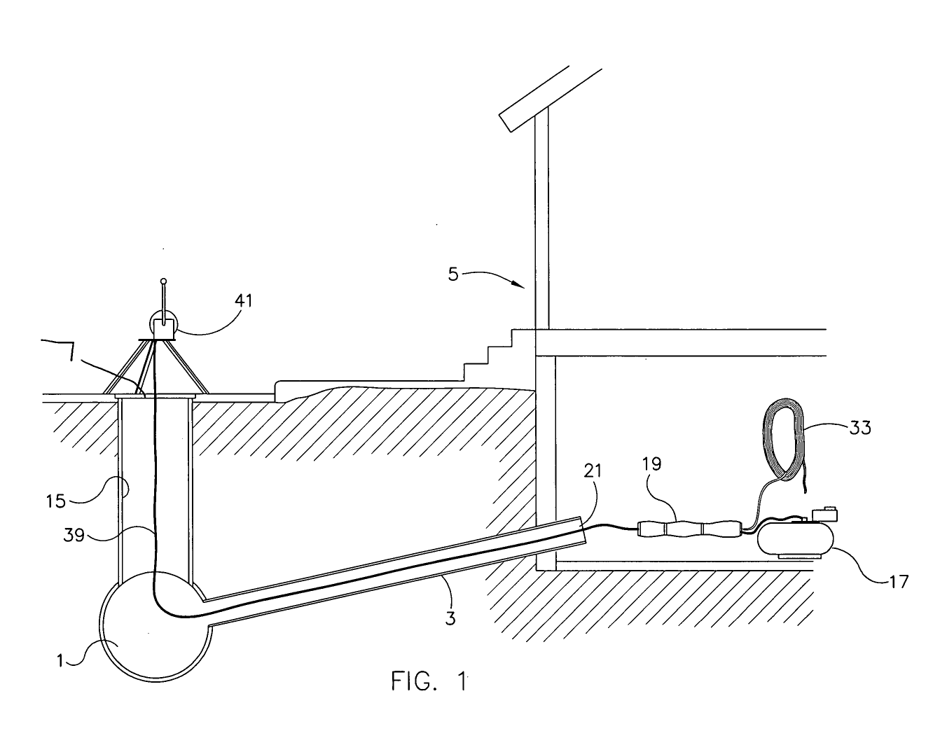

Now referring to the drawings in detail, wherein like-numbered elements refer to like elements throughout, FIG. 1 shows the type of sewer system for which the present invention is designed. More specifically, FIG. 1 shows a main sanitary sewer line 1, said main line 1 connecting a lateral line 3. Frequently, additional access is provided to the sewer main 1 line via manholes 7, which are located above the main sewer line 1. The lateral lines 3 often originate in buildings 5 along the main line 1 and are no longer required when the buildings 5 are demolished. In such a case, the lateral 3 would be cut from within the building 5. At this point, the process of forming the sewer plug would begin. As an initial matter, a bladder 7 having an inflated diameter slightly greater than the pipe 3 to be abandoned is provided. The bladder 7, should normally be sized such that, upon inflation, it can expand outwardly to fill the diameter of the lateral 3 as well as filling into any potential cavities or holes within the lateral 3 such that even damaged laterals 3 can be effectively sealed using the method and apparatus of the present invention. The bladder 11 normally has a sealed end 9 and an open end 8.

The bladder 11 is then fit into a sleeve 13. The sleeve 13 is generally of a fibrous material such as felt or glass fiber, although any woven fabric is acceptable. The sleeve 13 should also be sized such that it permits some expansion into any above-mentioned imperfections in the pipe to which it is inserted.

The sewer plug assembly 19 is generally assembled on the ground near a manhole 15, in the basement of a building 5, near a hole 21 dug to access the lateral 3, or at any other point of access to the sewer conduit, such as the clean out. As an initial matter, for ease of installation, the technician will normally inspect the pipe 3 to determine whether it is possible to insert the sewer plug assembly 19 and, if so, where in the pipe 3 it should be placed. Occasionally, due to pipe damage from roots or the cycle of thawing and freezing in northern climates, the pipe, or lateral 3, must be cleaned or cleared in order to properly place the sewer plug 19. There are many conventional means of clearing and cleaning the pipe 3 for placement of the sewer plug assembly 19 that will not be discussed here.

The next step is to prepare the epoxy sewer plug 19 for installation. As an initial matter, the technician sprays the bladder 11 with a silicone spray. At this point, the technician should have all the supplies conveniently available for installation. The catalyst and resin are then poured into a pail and mixed together. Normally, due to the thickness of the liquid and the desire for a high degree of consistency, a power mixer is employed.

The bladder 11 is then placed into the sleeve 13. Some embodiments of the present invention may provide for an integrated bladder and sleeve such that no additional steps are required before impregnating the sleeve 13 with resin. After the bladder 11 is placed in the felt sleeve 13, the open end 8 of the bladder 11 is filled with resin. Next, the outside of the bladder 11 is thoroughly coated with the resin in a process called “wetting out.” To complete this process, the bladder 11 and sleeve 13 are rolled with a device resembling a rolling pin. This process ensures that the material to be cured is distributed evenly and adequately throughout the felt sleeve 13 so that the felt liner will better adhere to the sides of the pipe, or lateral 3. Normally, a dye is added to the material to be cured to make the “wetting out” process more easily observable.

After the material to be cured has been added, the open end of the bladder 11 is sealed shut around an air fitting 25. The bladder 11 can be sealed in any number of ways including clamping, heat sealing, stapling, tacking although other fastening means are possible as well. However, before sealing, an air valve 25 is inserted into the open end of the bladder 11. The air valve 25 is then used to attach an air hose 27 to the air compressor 17.

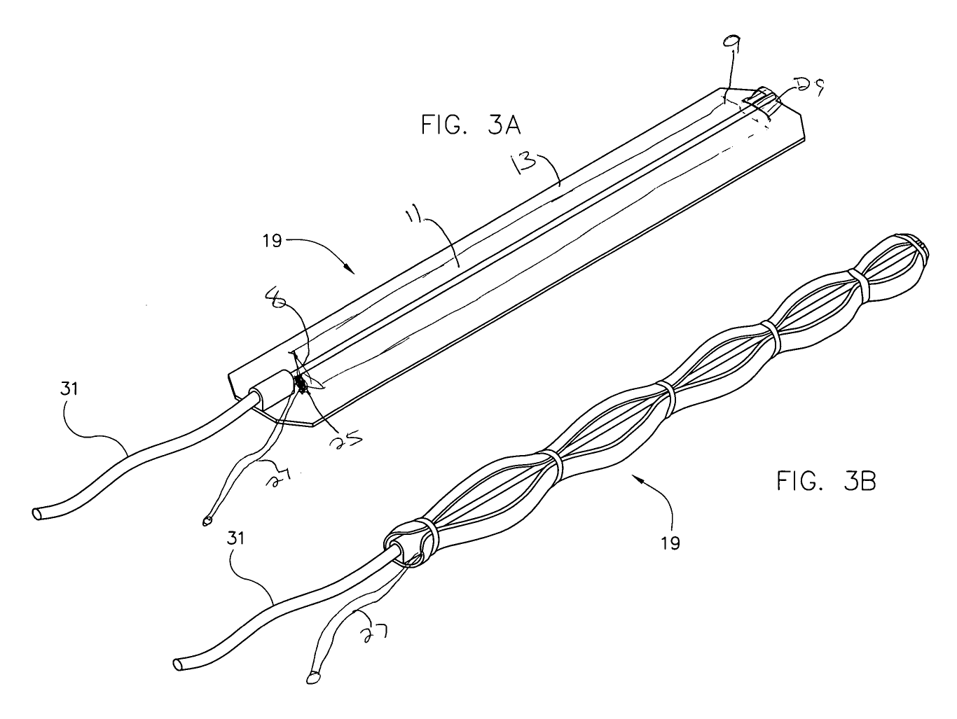

Before installation, the sewer plug assembly 19 is folded in half lengthwise for insertion into a lateral 3. See FIG. 3B. As discussed above, the sewer plug assembly 19 may need to be placed at some distance from its actual point of installation. That is, it is normally desirable to abandon the lateral 3 at a point close to the main sewer conduit 1 which also may be a distance from the point of installation. Additionally, it is desirable to place the sewer plug assembly 19 from a distance in order to prevent the need to excavate above the connection, therefore, the present invention provides for a camera 37 having a lens extendable into the lateral 3 such that the epoxy sewer plug 19 can be appropriately positioned.

A pipe lateral 3 which is to be sealed off is often located between a basement wall of a building 5 to be abandoned and a main sewer line 1. The method of the present invention generally provides for placement of the sewer plug in the lateral 3 at the juncture of the lateral 3 and the main sewer line 1. As discussed above, the main sewer line 1 is generally located underneath the street, some distance away from the building 5. Additionally, it is normally desirable place the sewer plug assembly 19 from a distance in order to avoid the need to excavate above the connection to the lateral 3, which could be underneath a busy street or intersection.

In a typical application, as shown in FIG. 1, when downstream access point is available, a common practice would be to send a rope 39 through the lateral 3 from the basement into the main sewer line 1. Such a situation may occur in the basement 5 of a building in which sewer service will be cut off before a demolition. The rope 39 is then pushed into the main sewer line 1 and let out until it floats to within reach of the next access point to the main sewer 1. The rope 39 then serves to pull the sewer plug 19 into position in the lateral 3 at its point of entry to the main sewer line 1. More commonly, the rope 39 is attached to a winch 41 on a tripod, which is used to pull the sewer plug 19 through the lateral 3.

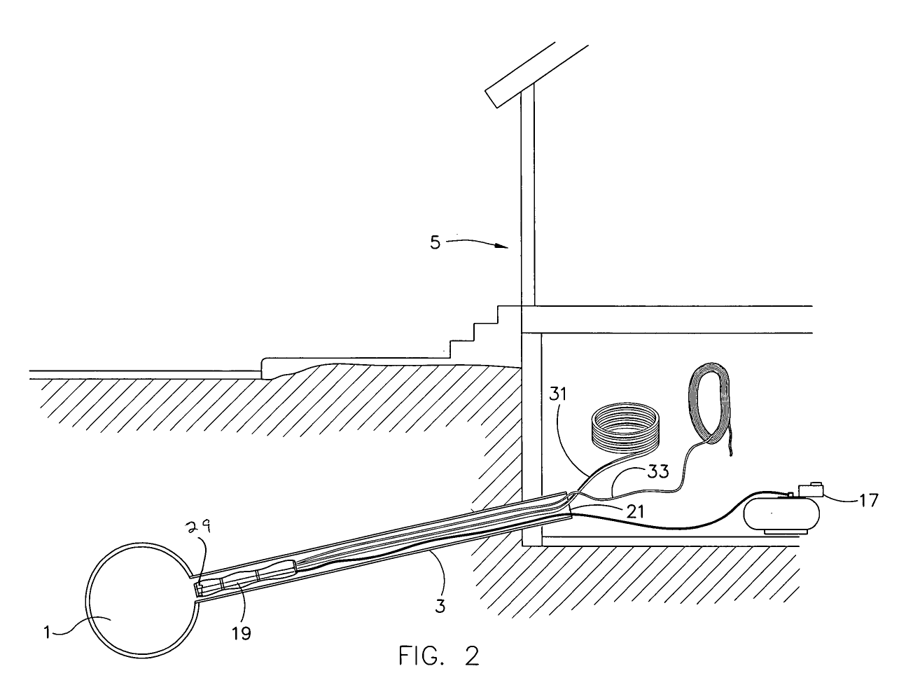

In the event it is impossible to secure the epoxy sewer plug 19 by floating a rope 39 downstream, such as when there is no convenient downstream access, as shown in FIG. 2, the sewer plug 19 could also be pushed through the lateral 3. Therefore, the method of the present invention typically provides for the use of a pushrod systems for positioning the sewer plug assembly 19 through a conduit in order to place it appropriately. The pushing means includes a smaller sleeve, or pocket 29, on the sleeve 13 into which the end of a push pole 31 of the type frequently could be inserted. In this manner, the push pole 31 could be used to push the sewer plug through the lateral 3 and then easily retrieved by simply pulling it out of the pocket 29. In the event the sewer plug 19 is misplaced, the sleeve or bladder of the sewer plug 19 may also include some means of attachment such as a loop, a hook, or any of such means known in the art to attach a rope 33 to withdraw the sewer plug. The rope 33 is also used to guide the sewer plug 19 over offsets and through elbows and other obstacles in the pipe when using the push pole 31 system.

When the sewer plug 19 is in location, the bladder is inflated using an air compressor attached to the air hose 27 to approximately 11 p.s.i. At this point, the sewer plug 19 is allowed to set until the resin fully hardens. The pressure is then reduced and the air hose is clamped and disconnected from the air compressor. The air hose is then tucked into the abandoned pipe and sealed within the abandoned pipe.

In summary, the present invention provides a method for abandoning a sewer pipe comprising the steps of:

identifying the main sewer line 1;

identifying the laterals 3 to be permanently abandoned;

accessing into the lateral 3;

finding a downstream access point to the main sewer line 1;

clearing the lateral 3 of debris and roots that could impede placement of the sewer plug 19;

floating a rope 39 through the lateral and downstream to the access point;

spraying a bladder 11 with silicon;

inserting the bladder 11 into a felt sleeve 13, said felt sleeve 13 having at least a loop at one end for attachment of a rope 39 or some other pulling means and potentially attachment points at both ends in addition to a sleeve 29, said sleeve 29 accommodating a push pole 31, or push rod;

filling the bladder 11 partially with an epoxy resin;

sealing the bladder 11 around an air fitting 25;

attaching an air hose 27 to the air fitting 25;

folding the combination of bladder 11 and felt sleeve 13 in half, lengthwise;

attaching the rope 39 to the sleeve 13, or bladder 11;

attaching a closed circuit miniature camera 37 to the leading end of the sewer plug;

pulling the rope 39 through the sewer 1, 3 such that the epoxy sewer plug 19 moves through the lateral 3 into position immediately outside the main sewer line 1;

inflating the bladder 11 with using a compressor 17 attached to the air hose 27;

permitting the sewer plug 19 to harden; and

withdrawing the air hose 27.

1. A method for sealing an abandoned sewer pipe comprising the steps of:
inserting an air-retaining bladder having an air receiving fitting into a felt sleeve;
filling the area between the felt sleeve and the bladder with resin to create the sewer plug;
placing the bladder and sleeve in the sewer pipe to be abandoned;
connecting the bladder to an air compressor using an air hose;
inflating the bladder using the air compressor; and
permitting the sewer plug to harden.

2. The method of claim 1 further comprising the steps of:
identifying the main sewer line;
identifying a lateral to be permanently abandoned;
accessing into the lateral;
finding a downstream access point to the main sewer line; and
clearing the lateral of debris and that could impede placement of the sewer plug.

3. The method of claim 1 further comprising the steps of:
attaching a rope to the felt sleeve;
floating the rope through the lateral and downstream to the access point; and
pulling the felt sleeve and bladder through the pipe to place the sewer plug a desired.

4. The method of claim 1 further comprising the step of attaching a closed circuit miniature camera to the leading end of the sewer plug.

5. The method of claim 1 further comprising the step of pulling the rope through the sewer such that the epoxy sewer plug moves through the lateral into position immediately outside the main sewer line.

6. The method of claim 1 further comprising the steps of:
inserting the bladder into a felt sleeve, the felt sleeve having at least a loop at one end for attachment of a rope or some other pulling means and potentially attachment points at both ends in addition to a sleeve, said sleeve accommodating a push pole; and
pushing the felt sleeve into place at the point where the lateral enters the main sewer line using a push pole.

7. A method for sealing an abandoned sewer pipe comprising the steps of:
inserting an air-retaining bladder having an air fitting into a felt sleeve, the felt sleeve having at least a loop at one end for attachment of a rope or some other pulling means and a smaller pocket at one end, the pocket accommodating a push pole
filling the area between the felt sleeve and the bladder with resin to form the sewer plug;
inserting the push pole within the pocket in the sleeve;
connecting the bladder to an air compressor using an air hose;
guiding the sewer plug into place in the sewer pipe to be abandoned using the push pole;
inflating the bladder using an air compressor; and
permitting the sewer plug to harden.

8. The method of claim 7 further comprising the steps of:
identifying and locating the main sewer line;
identifying a lateral to be permanently abandoned;
accessing into the lateral;
finding a downstream access point to the main sewer line; and
clearing the lateral of debris that could impede placement of the sewer plug.

9. The method of claim 7 further comprising the steps of:
attaching a rope to the felt sleeve;
using the combination of the push rod and the rope to guide the sewer plug into place as desired.

10. The method of claim 7 further comprising the step of attaching a closed circuit miniature camera to the leading end of the sewer plug to guide the sewer plug into place.

11. The method of claim 7 further comprising the step of:
attaching a rope to the felt sleeve of the sewer plug;
floating the rope through the lateral and downstream to the access point; and
pulling the felt sleeve and bladder through the pipe to place the sewer plug is desired.

12. A method for abandoning a sewer pipe comprising the steps of:
identifying the main sewer line;
identifying a lateral to be permanently abandoned;
accessing into the lateral;
finding a downstream access point to the main sewer line;
clearing the lateral of potential debris and roots that could potentially impede placement of the sewer plug;
floating a rope through the lateral and downstream to the access point;
inserting an air retaining bladder having an air fitting into a felt sleeve, the felt sleeve having a loop at one end for attachment of a rope or some other pulling means and a pocket, said pocket accommodating a push pole;
filling the area between the felt sleeve and the bladder with resin;
inserting the push pole into the pocket;
sealing the bladder around an air fitting;
attaching an air hose to the air fitting;
folding the combination of bladder and felt sleeve in half lengthwise to form the sewer plug;
inserting the sewer plug into the lateral at a convenient access point;
attaching the rope to the sleeve, or bladder;
pushing the sewer plug through the later using the push pole such that the sewer plug moves through the lateral into position immediately outside the main sewer line;
inflating the bladder with using a compressor attached to the air hose;
permitting the sewer plug to harden; and
clamping and cutting the air hose; and
sealing the end of the air hose in the pipe.

13. The method of claim 13 further comprising the step of attaching a closed circuit miniature camera to the leading end of the sewer plug to guide the sewer plug into place.

14. An apparatus for sealing an abandoned sewer line comprising:
a felt sleeve having a pocket and a rope retaining means at one end;
an inflatable bladder having an air fitting fitted within the felt sleeve;
a quantity of resin sufficient to fill the area between the bladder and the sleeve;
a push pole inserted into the pocket in the felt sleeve;
an air compressor having a hose attachable to the air fitting of the bladder;
a rope attachable to the felt sleeve for manipulating the bladder through obstacles in a sewer pipe in combination with the push pole.

15. The apparatus for abandoning a sewer line of claim 15 further comprising a closed circuit miniature camera to the leading end of the sewer plug to guide the sewer plug into place.
